(19) United States
(12) Patent Application Publication
(10) Pub. No.: US 2007/0107409 A1
(43) Pub. Date: May 17, 2007

(54) Integrated rotary rake and inverter

(75) Inventors: John H. Posselius, Ephrata, PA (US); Kenneth R. Underhill, Strasburg, PA (US)

Correspondence Address: CNH AMERICA LLC, INTELLECTUAL PROPERTY LAW DEPARMENT, PO BOX 1895, M.S. 641, NEW HOLLAND, PA, 17557, US

(73) Assignee: CNH America LLC, New Holland, PA (US)

(21) Appl. No.: 11/260,892

(22) Filed: Oct. 27, 2005

(51) Int. Cl. A01D 78/00

(52) U.S. Cl. 56/377

(57) ABSTRACT

A single farm machine can form or invert crop windrows by using only the raking tines of a conventional rotary rake machine. For raking, the tines simply discharge the crop to one side of the machine. The machine is changed from a raking mode into an inverting mode by adjusting the locations on the circle of revolution of the tines at which the tines engage and disengage an existing windrow. The windrow is inverted when the tines engage the windrow, lift it, and impart motion to the crop as it is being discharged that has a vector that is in the same direction as the movement of the machine. This causes the crop to move faster than the machine itself and inverts the windrow by pushing the disengaging crop over the crop that was previously discharged.

### BACKGROUND OF THE INVENTION

This invention deals generally with farm machinery and more specifically with an apparatus to changeover a rotary raking machine into a windrow inverting machine. Prior art farm machines include separate raking machines and windrow inverter machines. The rake picks up scattered crop and deposits it into a windrow, a long continuous pile of crop, and, at a later time, an inverter is used to turn the windrow over so that the previous bottom portion of the windrow will dry.

The typical rake machine is pulled behind a tractor and includes an assembly of extending arms formed into a pinwheel-like configuration which revolves in a horizontal plane. Each arm holds a group of wire tines that extend to the ground during part of the revolution of the arm assembly. In order to form the windrow, each arm is rotated on its axis to orient its tines vertically down with their ends at the ground to perform the raking operation. Then the arms are rotated to lift the tines up to approximately a horizontal orientation to stop the raking action and permit the formation of the windrow.

The typical rake machine divides the two positions of the tines into approximate halves of the circle of revolution of the arms. The tines are down and dropping or lifting as they pass the front of the machine, at the portion of the circle nearest to the tractor, and are then up as they pass the part of the circle most remote from the tractor. This motion rakes the crop from one side of the crop rake, toward the tractor, and then pushes it to one side of the path, forming the windrow.

Prior art inverters essentially continuously pick up the windrow, reorient it, and lay it back down on the ground. U.S. Pat. No. 4,730,447 by Fisher uses tines in a belt arrangement to lift crop up a ramp onto a disc shaped platform with a circumferential wall. A pinwheel type assembly then drives vertically oriented tines that move the crop around the platform until it is moving in the same direction of travel as the tractor where it is pushed over a downward curved edge and onto the ground.

U.S. Pat. No. 5,251,431 by Shoop uses a cylindrical type rake rotating on a horizontal axis to invert the crop while throwing it onto a tilted rotating disc from where it is propelled to the ground while the crop is oriented approximately at a right angle to the direction of movement of the tractor.

U.S. Pat. No. 6,354,429 discloses an inverter that uses a sloped conveyor belt to lift the windrow onto a curved conveyor and a discharge conveyor to convey the crop from the opposite side of the curved conveyor to a location where it is dropped to the ground while the crop is moving in the same direction as the tractor.

The Fisher and Kuhlmann machines accomplish the inverting by discharging the crop while the crop itself is moving so as to produce a greater speed differential between the crop and the ground than between the machine and the ground. This makes the speed of the crop relative to the ground greater than that of the platform from which it is dropped and causes the inverting of the crop.

However, the prior art windrow inverters have a significant problem. They all require a separate machine different from the crop rake or at least an additional apparatus used with a crop rake machine to accomplish the inverting. This adds a significant investment to any farming operation.

It would be very beneficial to construct a single machine that that can perform both the raking and inverting functions.

### SUMMARY OF THE INVENTION

The present invention permits one machine to rake crop into windrows and, with a minor changeover without any parts added or replaced, to invert windrows. The invention is integrated into a conventional rotary raking machine of the type that was previously described. Such a machine is pulled behind a tractor and includes an assembly of extending arms formed into a configuration which revolves in a horizontal plane. Each arm holds a group of wire tines that extend to the ground during part of the revolution of the arm assembly. In order to form the windrow, each arm is rotated on its axis to orient its tines vertically down with their ends at the ground to perform the raking operation. Then the arms are rotated to lift the tines up to approximately a horizontal orientation to stop the raking action and permit the formation of the windrow.

The present invention provides a relatively simple modification to such a machine to permit it to pick up a windrow and drop it to the ground while the rake tines, and therefore the crop, are moving in the same direction as the movement of the machine. This produces the required action for inverting a windrow, but does so with the same machine that is also used to initially form the windrow. This change in function is accomplished by changing, and almost reversing, those portions of the circular path of the rake's tines during which the tines are on the ground and during which they are raised up.

The raking operation divides the two positions of the tines into approximate halves of the circle of revolution of the arms. During the raking operation the tines are down as they pass the front of the machine, at the portion of the raking circle nearest to the tractor. Then the tines are up as they pass the part of the circle most remote from the tractor. This motion rakes the crop and then pushes it to one side of the path, forming a windrow.

However, in the present invention, for the inverting operation the tines are down in the region of the rear of the crop rake machine, the part of the rake machine most remote from the tractor, and up as they pass nearest to the tractor. This seemingly minor change means that the tines engage the windrow, lift it, move it around the machine, and then drop the crop from that side of the machine where the tines are moving in the same direction as the machine is moving. The surprising result is that, even without the addition of conveyors or rotating discs, as long as the motion of the crop as it leaves the tines has some vector of its movement in the direction of the motion of the machine, the windrow is inverted. This is because when a first part of the windrow hits the ground, the following part of the windrow, which is traveling at the tine speed plus the machine speed, is pulled over the previously discharged part of the windrow, thereby rolling the windrow over.

The changeover from the rake mode to the inverter mode is accomplished by a relatively simple structure. To move the tines up and down the holding arms on which the tines are mounted are rotated, and this rotation is caused by the structure of the arms. Each arm has a crank arm structure on its end near the center of revolution of the arm assembly. That is, each tine holding arm has on its end a crank arm protruding perpendicular to the axis of the tine holding arm. Attached to the end of the crank arm is a cam follower.

A cam, which is essentially a ring structure, is located at the center structure of the arm assembly and locked in place to prevent inadvertent rotation. As the arms and the outer portion of the arm assembly revolve around the center structure, the cam followers on the ends of the crank arms ride around on the cam, and the rotation of the arms is controlled by the cam. In the preferred embodiment of the invention, the crank arms are oriented in approximately the same plane as the tines. Thus, when the crank arms are horizontal the tines are up and also approximately horizontal, while when the tines are down and approximately vertical the crank arms are also vertical. The movement of the crank arms between the horizontal and vertical orientations is accomplished by the structure of the cam.

A portion of the circumference of the ring shaped cam is at the same height as the axes of the tine arms, so that when the cam followers are on that part of the cam the crank arms are in a horizontal orientation. The cam also has a region in which it rises to and remains at a height equal to the length of the crank arms, so that when the cam followers are on that high part of the cam, the crank arms are oriented vertically, orienting the tines vertically and placing them on the ground. The shape of the cam therefore determines the positions of the tines as the arm assembly revolves around the center of the rake machine.

The present invention not only uses the cam to control the position of the tines, but also permits the rotation of the cam itself to permit the regions in which the tines are up or down to be varied according to whether the machine is to be used for raking or inverting. For the raking operation the high part of the cam is located toward the front of the machine, the portion nearest to the tractor, and for inverting the high part of the cam is located near the rear of the machine, away from the tractor.

The rotation of the cam is accomplished by the configuration of the center structure of the arm assembly. The center structure of the arm assembly includes several cylindrical sleeves concentric to the basic axle which supports the revolving arm assembly. The cam extends out radially from a cam support sleeve that is around the axle, and a handle also extends out radially from the cam support sleeve. The handle serves to rotate the cam to position the high part of the cam for either raking or inverting. A spring loaded lock pin is attached to the handle so that the handle and cam can be locked into the appropriate position as the pin is inserted into holes on the machine frame. Another sleeve concentric to the axle is attached to the support for the tine arms and includes a ring gear by which the arm assembly is revolved.

The present invention thereby furnishes a single machine that can perform the two operations of raking and inverting, which in the prior art always required two separate machines.

### BRIEF DESCRIPTION OF THE DRAWINGS

FIG. 1 is a schematic diagram of the top view of the preferred embodiment of the rake-inverter machine of the invention showing the pattern of movement of the tines when used for raking.

FIG. 2 is a schematic diagram of the top view of the preferred embodiment of the rake-inverter machine of the invention showing the pattern of movement of the tines when used for inverting.

FIG. 3 is a schematic partial cross section side view of the rake-inverter machine of the preferred embodiment of the invention with only the cam and its associated parts shown with crosshatching.

### DETAILED DESCRIPTION OF THE INVENTION

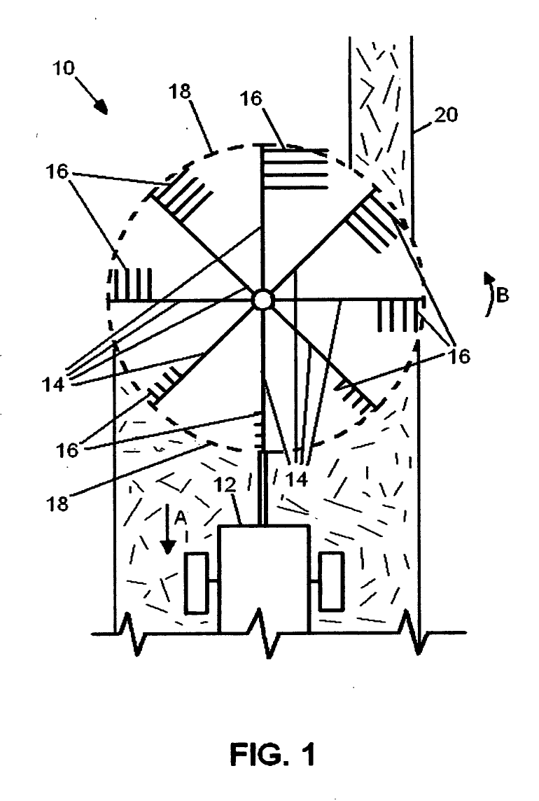

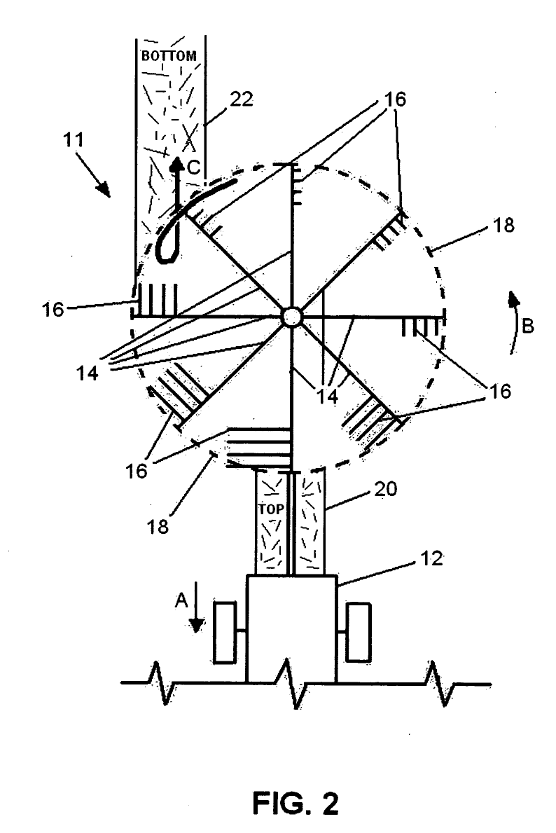

FIG. 1 is a schematic diagram of the top view of the preferred embodiment of rake-inverter machine 10 of the invention showing the pattern of movement of tines 16 when machine 10 is set-up and used for raking. FIG. 2 is a schematic diagram of the top view of the same preferred embodiment of rake-inverter machine 10 showing the pattern of movement of tines 16 when machine 10 is set-up and used for inverting windrows.

Machine 10 is connected to and pulled by tractor 12 that propels machine 10 in the direction indicated by arrow A, and machine 10 includes several revolving arms 14 that each hold sets of tines 16. The orientation of each set of tines 16 changes depending upon the location of its arm 14 within circle of revolution 18. It should be appreciated that, since FIGS. 1 and 2 are top views, when tines 16 appear longest, they are in an approximately horizontal orientation and not engaging the crop on the ground, while when tines 16 appear shortest they are oriented approximately vertically and engaging the crop that is on the ground. Intermediate lengths of the tines indicate that they are changing their orientation between these two extremes.

As shown in FIG. 1, for raking, crop machine 10 moves the tines down to engage the crop as the arms revolve into the region of circle of revolution 18 nearest to the tractor. At that location, tines 16 contact the crop on the left side of FIG. 1, and the movement of the arms 14 and tines 16 rakes the crop from that side of machine 10, toward tractor 12, and then pushes the crop to one side of the tractor's path, forming windrow 20 on the right side of FIG. 1. This movement is based upon the counter clockwise revolution of arms 14 as indicated by arrow B, and the particular location of windrow 20 would be changed if the direction of revolution were changed.

As shown in FIG. 2, for inverting windrows, machine 10 moves the tines down to engage the crop as the arms revolve into the region of circle of revolution 18 farthest from the tractor. At that location, tines 16 contact existing windrow 20, and the movement of arms 14 and tines 16 picks up and moves the crop from one side of machine 10, away from tractor 12, and then drops the crop on the other side of the path, forming inverted windrow 22 on the left side of FIG. 2.

Dropping the crop from the opposite side of machine 10 means that, when the windrow is disengaged, tines 16 are moving in the same direction that machine 10 is moving. In the preferred embodiment of FIG. 2 the tines are set to release the crop when the tine driven crop is traveling almost fully in the same direction as machine 10. Viewing circle of revolution 18 as a clock, FIG. 2 shows the tines lowering at approximately 3 o'clock and discharging the crop at approximately 9 o'clock. With such a disengagement position, the forward motion of the tine peripheral speed added to the inverter machine ground speed causes the crop to be pulled over crop that was discharged just before it, thereby rolling over, or inverting, the windrow. It is the speed of the discharging crop relative to the ground that controls the inverting action. Thus, as indicated by the Top and Bottom labels in FIG. 2, the top surface of original windrow 20 ends up nearer to the ground and hidden from view in inverted windrow 22, while the bottom portion of original windrow 20 is seen at the top of inverted windrow 22. Arrow C in FIG. 2 shows the path traveled by the crop material as it is released from tines 16 as they are rotated upward. It should be appreciated that the width of windrow 20 is not a limitation on the effectiveness of the inverter mode of the invention since tines 16 can actually be down and set to engage the crop over a significant portion of circle of revolution 18.

Thus, the only requirement for changing over machine 10 from the raking mode to the inverting mode is to adjust the portions of circle of revolution 18 of arms 14 during which tines 16 are rotated into and out of contact with the crop.

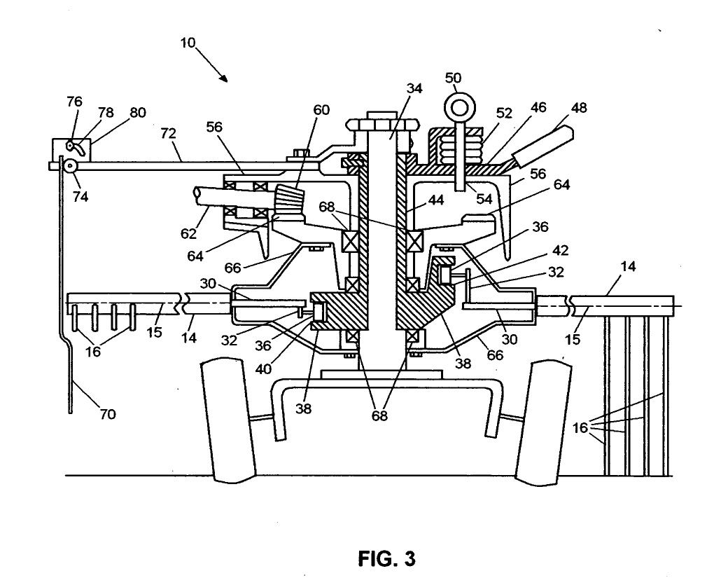

To successfully invert the windrow it is only necessary that when being discharged the crop should have at least some forward vector component in its motion that is in the same direction as the forward motion of machine 10. Even with a minimal forward vector of motion, as the crop is released from the tines there is sufficient speed so that when a first part of the crop hits the ground the following crop is pulled over the crop that was previously discharged, and the windrow is inverted. Thus, the only requirement for changing rotary rake machine 10 into its inverter mode is to change the portions of circle of revolution 18 during which tines 16 are rotated into and out of contact with the crop. In the preferred embodiment of the invention this is accomplished by the structure shown in FIG. 3.

FIG. 3 is a schematic partial cross section side view of rake-inverter machine 10 of the preferred embodiment of the invention with only cam 38 and its associated parts shown with crosshatching.

The changeover of machine 10 from the rake mode to the inverter mode is accomplished by a relatively simple structure. To accomplish the raising and lowering of tines 16 as described in regard to FIGS. 1 and 2, each holding arm 14 on which tines 16 are mounted is rotated on its length axis 15. This rotation is implemented by the structure of arms 14. Each arm 14 has an extension 30 with a crank arm 32 attached on the end of extension 30 that is nearest rake-inverter axle 34 around which arms 14 revolve. Crank arm 32 is oriented perpendicular to axis 15 of arm 14, and cam follower 36 is attached to the end of crank arm 32.

Cam followers 36 ride on cam 38, which is a cylindrical structure surrounding and concentric with axle 34. As arms 14 are moved around center axle 34 and cam 38, cam followers 36 on the ends of crank arms 32 ride around on cam 38, and the rotation of arms 14 is controlled by cam 38. In the preferred embodiment of the invention, the crank arms are oriented in approximately the same plane as the tines. Thus, when crank arms 32 are horizontal tines 16 are up and also approximately horizontal, while tines 16 are down and approximately vertical when crank arms 32 are vertical. This orientation in the same plane is not required for operation of the invention, but it is a simple arrangement to facilitate understanding of the operation.

The movement of crank arms 32 between the horizontal and vertical orientations is accomplished by the structure of cam 38. A low region 40 of the circumference of cam 38 is at approximately the same height as the axes of arms 14, so that when cam followers 36 are on low region 40 of cam 38, crank arms 32 are in a horizontal orientation. Cam 38 also has a high region 42 in which it rises to and remains at a height approximately equal to the length of crank arms 32. In high region 42 crank arms 32 are oriented vertically and tines 16 are engaging crop on the ground. The shape of cam 38 therefore determines the positions of tines 16 as arms 14 revolve around axle 34 of rake-inverter machine 10.

The present invention also permits the rotation of cam 38 to permit the regions of the circle of revolution of arms 14 in which the tines are up or down to be varied according to whether the machine is to be used for raking or inverting. In the preferred embodiment, for the raking operation high portion 42 of cam 38 is located toward the front of rake-inverter 10, the part of machine 10 nearest to the tractor, and for inverting, high portion 42 of cam 38 is located near the rear of rake-inverter 10, away from the tractor.

The controlled position change of cam 38 is accomplished by the configuration of the center structure of rake-inverter 10. The center structure of rake-inverter includes several cylindrical sleeves concentric to axle 34 which supports the entire structure. Cam 38 extends out radially at the bottom of support cylinder 44 that is around axle 34, and adjustment arm 46 and handle 48 extend out radially from the top of support cylinder 44. Adjustment arm 46 and handle 48 serve to rotate cam 38 to position high region 42 of cam 38 for either raking or inverting. Lock pin 50 which is controlled by spring 52 is attached to adjustment arm 46 so that adjustment arm 46 and cam 38 can be locked into the appropriate position as lock pin 50 is inserted into holes 54 on machine frame 56.

FIG. 3 shows the mechanism that supplies power to revolve arms 14. Drive gear 60 is rotated by shaft 62 which is driven by the power take-off (not shown) of tractor 12. Drive gear 60 engages and turns ring gear 64 that is structurally attached to arm assembly frame 66 which revolves around axle 34. Arms 14 are all mounted upon frame 66. Bearing 68 is one of several such bearings (all indicated by an enclosed “X”) which facilitate movement between the concentric cylinder structures of machine frame 66, ring gear 64, and cam 38 that surround axle 34.

FIG. 3 also shows another structure that adds versatility to the process of inverting the windrows. Limiting shield 70 is attached to frame 56 by means of support arm 72, and is located in the region where the lifted windrow is being dropped from the tines. Limiting shield 70 extends vertically downward from support arm 72 and includes a curve to offset it toward the center of inverter 10. Limiting shield 70 operates to restrict sideward movement of the crop as it is discharging from tines 16. At high speeds limiting shield 70 permits either maintaining a windrow configuration when the shield is in service or spreading out the inverted crop for further drying when the shield is out of service. Limiting shield 70 is attached to support arm 72 by pivot 74, and it can be taken out of service by simply pulling its lower end up after unlocking bolt 76. Bolt 76 rides within curved slot 78 in bracket 80 and can be locked in either the raised or lowered positions.

The rake-inverter of the invention can be used for both raking crop into windrows and for inverting existing windrows, thereby completely eliminating the need for two separate machines. Furthermore, the changeover from one mode of operation to the other is a very simple operation, and requires no replacement parts.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

For example, the exact regions in which tines 16 engage the crop or windrows can be adjusted to accommodate particular crops and crop conditions, and the specific means by which arms 14 are revolved and rotated on their axes can also be changed. Furthermore, more or fewer arms 14 can rotate around axle 34.

What is claimed as new and for which Letters patent of the United States are desired to be secured is:

1. In a farm machine for raking crop, comprising an arm assembly which: revolves in a horizontal plane around an axle and includes radially extending arms, with each arm having attached raking tines that engage crop on the ground during a first portion of the assembly's revolution path, and the tines are disengaged from the crop during a second part of the assembly's revolution path, the improvement comprising:
adjustment apparatus for changing the orientation of the first and second portions of the arm assembly's revolution path relative to the direction of motion of the farm machine, so that at a first orientation of the first and second portions of the arm assembly's revolution path the tines form a windrow, and at a second orientation the tines move a windrow, and as the windrow disengages from the tines, the crop is inverted from its previous condition.

2. The farm machine of claim 1 wherein the adjustment apparatus comprises:
a support cylinder concentric with and rotatable around the axle;
a locking mechanism interconnected with and holding the support cylinder in at least a first and a second location around the axle;
a tine control apparatus interconnecting each arm with the support cylinder and causing each arm's tines to engage and disengage from the crop, with the tines movement relative to the arm's position on the rotation path dependent upon the location of the support cylinder around the axle; and
a turning device attached to the support cylinder and rotating the support cylinder.

3. The farm machine of claim 2 wherein the tine control apparatus comprises:
a cam attached to the support cylinder with the cam forming a ring around the support cylinder and including a higher portion and a lower portion;
a cam follower interconnected with each arm with the cam follower held in contact with the cam; and
a crank arm interconnecting each cam follower to its arm and causing the arm to rotate and also rotate the tines as the cam follower moves between the higher and lower portions of the cam as the arms rotate around the locked support cylinder.

4. The farm machine of claim 2 wherein the turning device comprises an adjustment arm attached to the support cylinder.

5. The farm machine of claim 2 wherein the turning device comprises an adjustment arm attached to the support cylinder, and the locking mechanism is a spring loaded pin attached to the adjustment arm, with the pin fitting into holes on a frame member of the farm machine.
